(19) United States
(12) Patent Application Publication
(10) Pub. No.: US 2019/0132476 A1
(43) Pub. Date: May 2, 2019

(54) INFORMATION PROCESSING DEVICE AND INFORMATION PROCESSING SYSTEM

(71) Applicant: SHARP KABUSHIKI KAISHA, Sakai City (JP)

(72) Inventors: TAKASHI SAWANO, Sakai City (JP); MAYUKO YOSHIDA, Sakai City (JP); KUMIKO OGINO, Sakai City (JP); YASUHIRO NAKAI, Sakai City (JP); MASAO SAEDA, Sakai City (JP)

(21) Appl. No.: 16/177,443

(22) Filed: Nov. 1, 2018

(30) Foreign Application Priority Data
Nov. 1, 2017 (JP) 2017-212189

(51) Int. Cl. H04N 1/32; H04N 1/00; H04M 3/51

(52) U.S. Cl. CPC H04N 1/32122; H04N 1/00424; H04M 3/5183; H04N 1/00233; H04N 1/00129; H04N 1/00079

(57) ABSTRACT

An information processing device includes a display. The information processing device receives a user operation through a graphical user interface (GUI) which is displayed on the display. A plurality of operation screens, which include a first home screen, is displayed on the display. Identification information corresponding to each of the plurality of operation screens is displayed in the operation screen.

### BACKGROUND

### 1. Field

The present disclosure relates to an information processing device and an information processing system, and, particular to, an information processing device and an information processing system which are capable of performing, for example, a plurality of functions.

### 2. Description of the Related Art

Japanese Unexamined Patent Application Publication No. 2016-186820 discloses an example according to the related art. A multimedia terminal according to the related art includes a display, and receives a user operation through a graphical user interface (GUI) displayed on the display. In addition, the multimedia terminal according to the related art includes a telephone, and thus a voice communication is enabled with a clerk at a center in a case where a trouble occurs while the multimedia terminal is operated, in a case where service content of the multimedia terminal or an operation method thereof is not known, and the like.

However, in the multimedia terminal according to the related art, a user of the multimedia terminal has to explain a situation to the clerk at the center only by voices, and thus it is difficult to transmit correct information from the user to the clerk at the center. Therefore, there is a problem that it is not possible for the clerk at the center to specify a screen currently displayed on the multimedia terminal, and thus it is not possible to provide a proper guide.

It is desirable to provide an information processing device and an information processing system, which are new.

It is further desirable to provide an information processing device and an information processing system which enables appropriate specifying of a screen that is currently displayed in a GUI including a plurality of operation screens.

### SUMMARY

According to an aspect of the disclosure, there is provided an information processing device capable of performing a predetermined function, the information processing device including: a first display and a first display control section. The first display control section causes a plurality of operation screens for performing the predetermined function to be switched, and causes the first display to display an operation screen. In each of the plurality of operation screens, identification information corresponding to the operation screen is displayed.

According to another aspect of the disclosure, there is provided an information processing system including: an information processing device according to the first aspect; and an image forming device capable of performing communication with the information processing device, in which the predetermined function is performed in cooperation with the information processing device and the image forming device.

According to still another aspect of the disclosure, there is provided an information processing system including: an information processing device according to the first aspect; and an operator information processing device operated by an operator in a call center, in which the information processing device further includes a call device to make a call with the operator in the call center, in which the operator information processing device includes a second display, an acquisition section, and a second display control section, in which the acquisition section acquires the identification information according to an operation of the operator, and in which the second display control section causes the second display to display the operation screen corresponding to the identification information acquired by the acquisition section.

### BRIEF DESCRIPTION OF THE DRAWINGS

FIG. 1 is a diagram illustrating an exterior configuration of an information processing system which is an example of the disclosure;

FIG. 2 is a block diagram illustrating an electrical configuration of an information processing device illustrated in FIG. 1;

FIG. 3 is a block diagram illustrating an electrical configuration of an image forming device illustrated in FIG. 1;

FIG. 4 is a diagram illustrating a configuration of the information processing system which includes an information processing device for a call center;

FIG. 5 is a diagram illustrating an example of a first home screen;

FIG. 6 is a diagram illustrating an example of a second home screen;

FIG. 7 is a diagram illustrating an example of a first copy setting screen;

FIG. 8 is a diagram illustrating an example of a second copy setting screen;

FIG. 9 is a diagram illustrating an example of a third copy setting screen;

FIG. 10 is a diagram illustrating an example of a fourth copy setting screen;

FIG. 11 is a diagram illustrating an example of a first scan setting screen according to a second embodiment;

FIG. 12 is a diagram illustrating an example of a second scan setting screen according to the second embodiment;

FIG. 13 is a diagram illustrating an example of a color setting screen according to the second embodiment;

FIG. 14 is a diagram illustrating an example of a monochrome setting screen according to the second embodiment; and

FIG. 15 is a diagram illustrating a code table according to the second embodiment.

### DESCRIPTION OF THE EMBODIMENTS

### First Embodiment

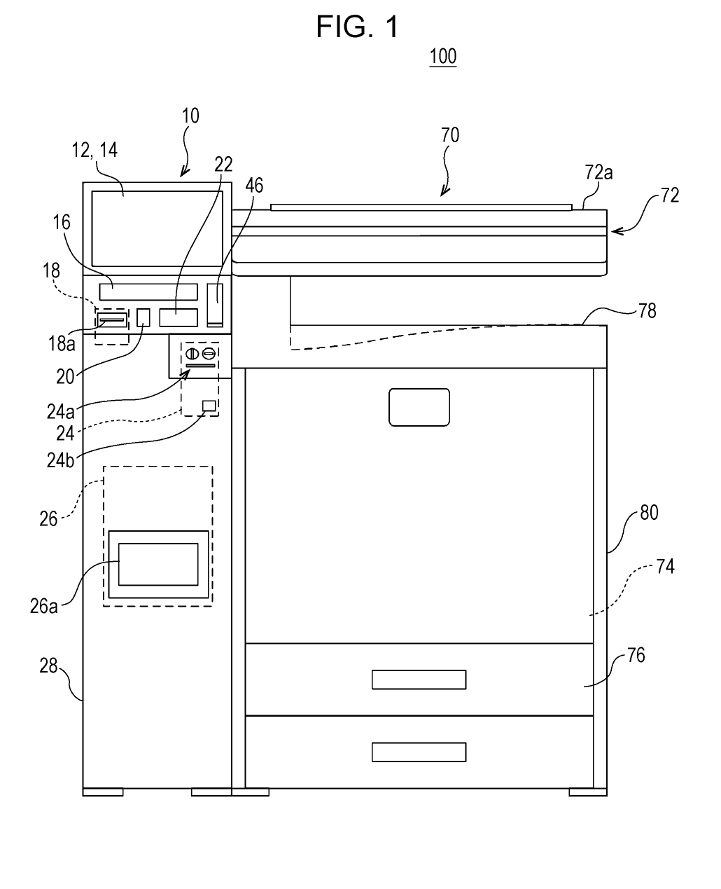

FIG. 1 is a diagram illustrating an example of a configuration of an information processing system 100 of the disclosure. Referring to FIG. 1, the information processing system 100 according to a first embodiment of the disclosure includes an information processing device 10 and an image forming device 70.

The information processing device 10 is a multimedia kiosk (MMK) terminal which is installed in a store, such as a supermarket, a restaurant, or a convenience store, or a public facility such as a station, a bus terminal, an airport, a government office, or a library. The information processing device 10 provides various pieces of information or a predetermined service (function) to a user according to a location where the information processing device 10 is disposed. In addition, although details will be described later, the information processing device 10 is capable of providing the predetermined service, such as copying, printing, scanning, or faxing, to the user in cooperation with the image forming device 70.

Meanwhile, in the specification, a front and back direction (a depth direction) of the information processing device 10 and configuration members thereof is prescribed while setting a surface which faces a location where the user stands, that is, a surface on a side where a display 14 which will be described later is provided to a forward surface (front surface), and a right and left direction (a lateral direction) of the information processing device 10 and the configuration members thereof is prescribed on the basis of a state in which the information processing device 10 is viewed from the user. The directions are the same as in the image forming device 70.

The information processing device 10 includes a device main body 28 which includes a display 14 equipped with a touch panel 12, a recording medium connection unit 16, a paper piece printer 18, a symbol reading unit 20, a near field communication unit 22, a money processing unit 24, a photo printer 26, and a call device 46.

The display 14 equipped with the touch panel 12 is disposed at an upper end part of the information processing device 10 (device main body 28). The touch panel 12 is a general-purpose touch panel, and a random type may be used such as an electrostatic capacity type, an electromagnetic induction type, resistive film type, or an infrared ray type, of the touch panel. In the first embodiment, an electrostatic capacity type touch panel is used as the touch panel 12, and the touch panel 12 is provided on a display surface of the display 14. However, a touch panel display, in which the touch panel 12 and the display 14 are integrally formed, may be used. In addition, for example, an LCD, an electro-luminescence (EL) display or the like may be used as the display 14.

The recording medium connection unit 16 includes a mounting portion (for example, a drive and a memory slot) used to mount various recording media. The various recording media includes an optical disk (for example, a CD-R, a DVD-R, or a BD-R), a flash memory (for example, a USB memory, an SD memory card, or a memory stick), and the like. However, the optical disk is mounted on the drive. In addition, the flash memory is mounted on the memory slot.

The paper piece printer 18 includes, for example, a thermal printer (thermosensitive printer) or a dot impact printer, and issues a paper piece, such as a receipt, a journal, or a coupon, on which an image is printed. Specifically, the paper piece printer 18 prints various strings, images, code patterns (a barcode and the like), or the like on a roll paper, and discharges a printed paper piece from a paper ejection unit 18a.

The symbol reading unit 20 includes, for example, a laser scanner, a camera, or the like, and is capable of reading a symbol which is attached to a product, a card, a receipt, or the like, a symbol which is displayed on a screen of the user terminal (mobile terminal), or the like. The symbol, which the symbol reading unit 20 is capable of reading, includes a barcode (one-dimensional barcode) or a 2-dimensional code (for example, a QR code (registered trade mark), a micro QR code, a Data MATRIX, a MaxiCODE, a VeriCODE, or the like).

For example, the near field communication unit 22 wirelessly performs contactless data communication with a communication target, such as an IC card (an identification card, a membership card, an employee card, or the like) or a user terminal, in conformity to a communication standard (so-called near field communication (NFC)), such as ISO/IEC18092, or the like. A communicable distance of the near field communication unit 22 is approximately a few centimeters to a few meters. The near field communication unit 22 transmits, to the communication target, a signal (read command) for instruction to read data stored in the communication target, with respect to the communication target. The communication target transmits desired data to the near field communication unit 22 in response to the read command. In addition, the near field communication unit 22 transmits data (write data) to be written in the communication target and a signal (write command) for instruction to write the data. The communication target writes (stores) the received write data in a storage unit of the communication target according to the write command.

The money processing unit 24 includes a money insertion part 24a and a coin return opening 24b. The money insertion part 24a includes a coin insertion opening, a paper money insertion opening, a change return lever, and the like, and is disposed below the near field communication unit 22 and the call device 46. A coin inserted from the coin insertion opening and paper money inserted from the paper money insertion opening are classified for respective types and are accommodated in predetermined money storage sections (not illustrated in the drawing). The money storage sections include a coin storage section and a paper money storage section. When the coin or the paper money is inserted, the amount of inserted money is calculated according to the type and the number of coins accommodated in the coin storage section and the type and the number of paper money accommodated in the paper money storage section. When the predetermined service or the like is performed in the information processing device 10, costs according to content of the service are subtracted from the amount of inserted money, and a balance of the amount of inserted money is calculated. In addition, when the change return lever is operated, a coin or paper money is returned according to the balance of the amount of inserted money. Meanwhile, the coin is returned from the coin return opening 24b provided below the money insertion part 24a, and the paper money is returned from the paper money insertion opening.

The photo printer 26 is, for example, a sublimation type printer or an ink jet printer, and prints an image on a photo paper. A photograph, which is printed by the photo printer 26, is discharged to a discharge unit 26a. Meanwhile, image data stored in a recording medium connected to the recording medium connection unit 16, image data transmitted from an external computer, or the like is used as image data to form the image on the paper. In addition, a size of the photograph to be printed by the photo printer 26 includes an L size, a postcard size, a 2L size, or the like.

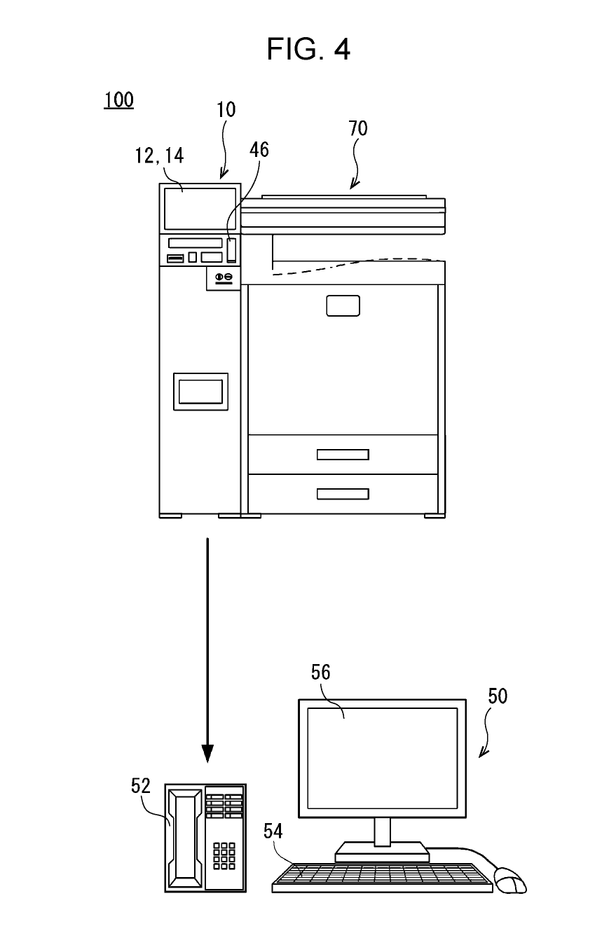

The call device 46 is a general-purpose call device which is used by the user of the information processing device 10, and includes, for example, a telephone, a headset, or the like. The call device 46 is used for the user to make a call with the operator in the call center in a case where a trouble occurs in the information processing device 10 or in a case where the service content of the information processing device 10 or an operation method thereof is not known. In addition, in a case where the call device 46 is a telephone which includes a telephone receiver and the telephone receiver is lifted, the call device 46 is automatically connected to a call device 52 (refer to FIG. 4) in the call center, thereby causing a state in which the user makes a call with the operator in the call center.

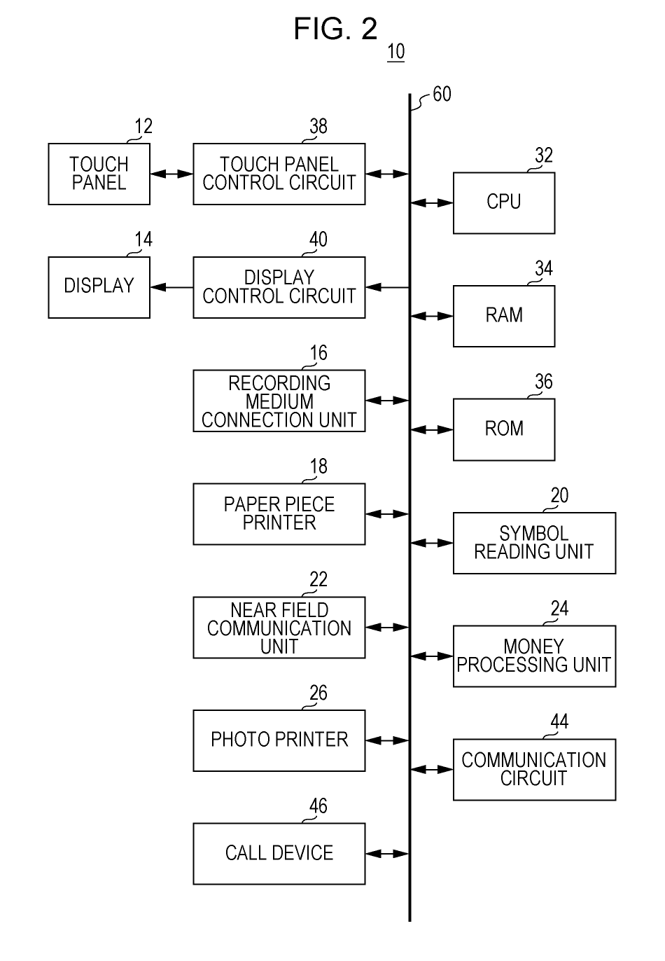

FIG. 2 is a block diagram illustrating an electrical configuration of the information processing device 10 illustrated in FIG. 1. Referring to FIG. 2, the information processing device 10 includes a CPU 32. A RAM 34, a ROM 36, a touch panel control circuit 38, a display control circuit 40, the recording medium connection unit 16, the paper piece printer 18, the symbol reading unit 20, the near field communication unit 22, the money processing unit 24, the photo printer 26, a communication circuit 44, and the call device 46 are connected to the CPU 32 through a bus 60. In addition, the touch panel 12 is connected to the touch panel control circuit 38, and the display 14 is connected to the display control circuit 40.

The CPU 32 performs overall control on the information processing device 10. The RAM 34 is used as a work area and a buffer area of the CPU 32. The ROM 36 stores a startup program of the information processing device 10 and default values for various pieces of information.

The touch panel control circuit 38 applies a desired voltage or the like to the touch panel 12, detects a touch operation (touch input) within an available touch range of the touch panel 12, and outputs touch coordinate data, which indicates a touch input location, to the CPU 32.

The display control circuit 40 includes a GPU, a VRAM, or the like. The GPU generates display image data to display various screens on the display 14, in the VRAM using image generation data stored in the RAM 34 under an instruction of the CPU 32, and outputs the generated display image data to the display 14.

The communication circuit 44 is a communication circuit enables connection to a network such as the Internet. The communication circuit 44 is a wired communication circuit or a wireless communication circuit, and communicates with an external computer (external terminal), such as a server, according to the instruction from the CPU 32 via the network. Meanwhile, the communication circuit 44 enables direct communication with the image forming device 70, a user terminal, or the like in a wired or wireless manner (for example, using an infrared ray method, a WiFi (registered trade mark) method, or a Bluetooth (registered trade mark) method) without passing via the network.

Meanwhile, the electrical configuration of the information processing device 10 illustrated in FIG. 2 is only an example, and the disclosure is not limited thereto.

Returning to FIG. 1, the image forming device 70 is a multifunction peripheral (MFP) which includes a copy function, a printer function, a scanner function, a facsimile function, and the like.

The image forming device 70 includes a device main body 80 which includes an image reading unit 72, an image forming unit 74, a paper feeding unit 76, and a paper discharge tray 78. Meanwhile, the image forming device 70 is installed in a vicinity of the information processing device 10. For example, the image forming device 70 is provided to be adjacent to the information processing device 10 on a right side thereof.

The image reading unit 72 includes a document platen which is formed of a transparent material, and is built in the device main body 80. A document pressing cover 72a is attached to an upper part of the document platen to be openable through a hinge or the like.

In addition, the image reading unit 72 includes a light source, a plurality of mirrors, an image formation lens, a line sensor, and the like. The image reading unit 72 exposes a document surface using the light source, and guides reflective light reflected from the document surface to the image formation lens through the plurality of mirrors. Furthermore, the image formation lens causes the reflective light to form the image on a light reception element of the line sensor. In the line sensor, brightness or chromaticity of the reflective light which forms the image on the light reception element is detected, and image data to be read is generated based on the image of the document surface. A charge coupled device (CCD), a contact image sensor (CIS), or the like is used as the line sensor.

The image forming unit 74 is built in the device main body 80, and is provided below the image reading unit 72. The image forming unit 74 includes a photosensitive drum, a charging section, an exposure section, a developing section, a transfer section, a fixing section, and the like. The image forming unit 74 forms an image on the recording medium (paper), which is transported from the paper feeding unit 76 or the like, using an electronic photograph method, and the paper, on which the image is completely formed, is discharged to the paper discharge tray 78 provided between the image reading unit 72 and the image forming unit 74. Meanwhile, image data which is read by the image reading unit 72, image data which is transmitted from the information processing device 10, image data which is transmitted from the external computer, or the like is used as the image data to form the image on the paper. In addition, the recording medium is not limited to the paper, and a sheet other than the paper, such as an OHP film, may be used.

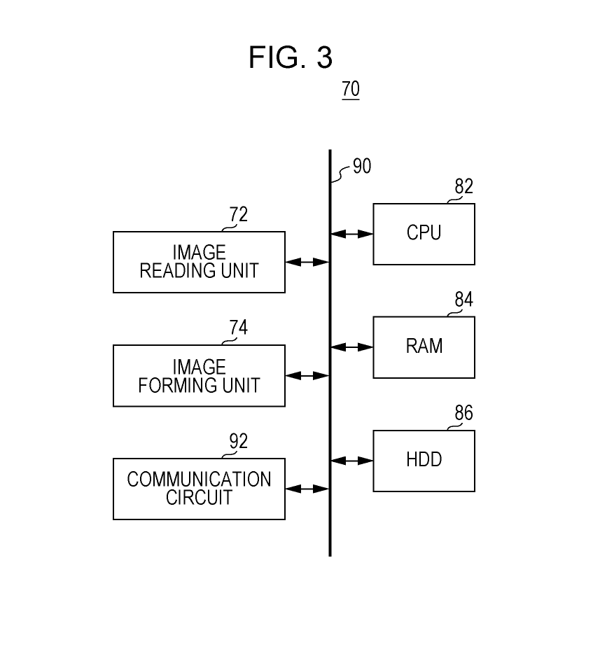

FIG. 3 is a block diagram illustrating an electrical configuration of the image forming device 70 illustrated in FIG. 1. Referring to FIG. 3, the image forming device 70 includes a CPU 82. A RAM 84, an HDD 86, the image reading unit 72, the image forming unit 74, and a communication circuit 92 are connected to the CPU 82 through a bus 90.

The CPU 82 performs overall control on the image forming device 70. The RAM 84 is used as a work area and a buffer area of the CPU 82.

The HDD 86 is a main storage unit of the image forming device 70, and appropriately stores a control program for the CPU 82 controlling operations of respective parts of the image forming device 70, the display image data for the various screens, and the like. However, instead of the HDD 86 or together with the HDD 86, another non-volatile memory, such as an SSD, a flash memory, or an EEPROM, may be used.

The communication circuit 92 is a communication circuit enables connection with the network such as the Internet. The communication circuit 92 is a wired communication circuit or a wireless communication circuit, and enables communication with the external computer, such as the server, via the network according to an instruction from the CPU 82. Meanwhile, the communication circuit 92 is capable of directly communicating with the information processing device 10 in the wired or wireless manner without passing via the network.

Meanwhile, the electrical configuration of the image forming device 70 illustrated in FIG. 3 is only an example, and it is not demanded to be limited thereto.

FIG. 4 is a diagram illustrating a configuration of the information processing system 100 which includes an information processing device 50 for a call center.

As illustrated in FIG. 4, the information processing system 100 includes the information processing device 50 for the call center and a call device 52 for the call center in addition to the information processing device 10 and the image forming device 70. However, the information processing device 50 for the call center and the call device 52 for the call center are used by an operator in the call center.

The information processing device 50 for the call center is a general-purpose computer (terminal) which is used by the operator in the call center, and, specifically, a desk top PC, a note (lap top) PC, a tablet PC, or the like corresponds to the information processing device 50 for the call center.

The information processing device 50 for the call center includes an input unit 54 and a display unit 56. The input unit 54 is, for example, a keyboard or/and a computer mouse. In a case where the input unit 54 is the keyboard, hardware operation buttons or operation keys are included. In addition, a touch panel may be used as the input unit 54.

The display unit 56 is, for example, an LCD. Meanwhile, an organic EL may be used as the display unit 56.

In addition, although not illustrated in FIG. 4, the information processing device 50 for the call center includes a control unit which performs overall control on the information processing device 50 for the call center, and a storage unit which stores the control program, various data, and the like.

The call device 52 for the call center is a general-purpose call device which is used by the operator in the call center, and includes, for example, a telephone, a headset, or the like.

In the information processing system 100 which has the above configuration, the information processing device 10 receives the user operation via the GUI which is displayed on the display 14. Specifically, the operation screen is displayed on the display 14 of the information processing device 10, and the user operation is received according to the touch input to the touch panel 12. For example, a home screen is displayed on the display 14 as an example of the operation screen. The home screen includes a plurality of icons which are assigned to the plurality of functions (services) that are allowed to be performed in the information processing system 100. In a case where any of the icons is selected through the user operation, various operation screens (setting screens) corresponding to the selected icon are displayed on the display 14. In the information processing device 10 or the image forming device 70, the predetermined service (function) is performed according to the content set in the setting screen.

Here, in the information processing system 100, it is possible for the user to make a call with the operator in the call center by voices using the call device 46 in a case where a trouble occurs in the information processing device 10 or in a case where the service content of the information processing device 10 or the operation method thereof is not known. Here, the storage unit of the information processing device 50 for the call center stores screen data for a screen, which is the same as the operation screen displayed on the display 14 of the information processing device 10, and it is possible to cause the display unit 56 to display the screen, which is the same as the operation screen displayed on the display 14 of the information processing device 10, according to an operation performed on the input unit 54 by the operator. Therefore, if a screen currently displayed in the information processing device 10 is specified, it is possible for the operator to provide a proper guide for an inquiry of the user while viewing the screen which is the same as the screen viewed by the user.

However, in the information processing device according to the related art, there is a case where the user is demanded to explain a situation to the operator in the call center only by voices and thus correct information is not transmitted to the operator from the user. If the information of the screen, which is currently displayed in the information processing device, is not correctly transmitted to the operator from the user, it is not possible for the operator to specify the screen, which is currently displayed in the information processing device, and thus there is a problem the proper guide is not provided for the inquiry of the user.

Here, in the first embodiment, identification information to specify the operation screen is embedded to each of the operation screens displayed on the display 14 of the information processing device 10.

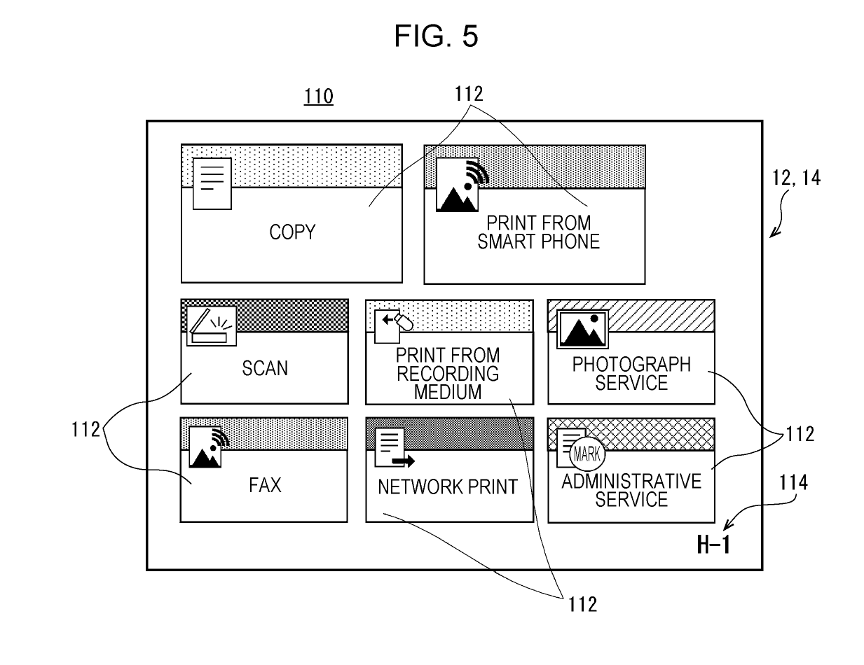

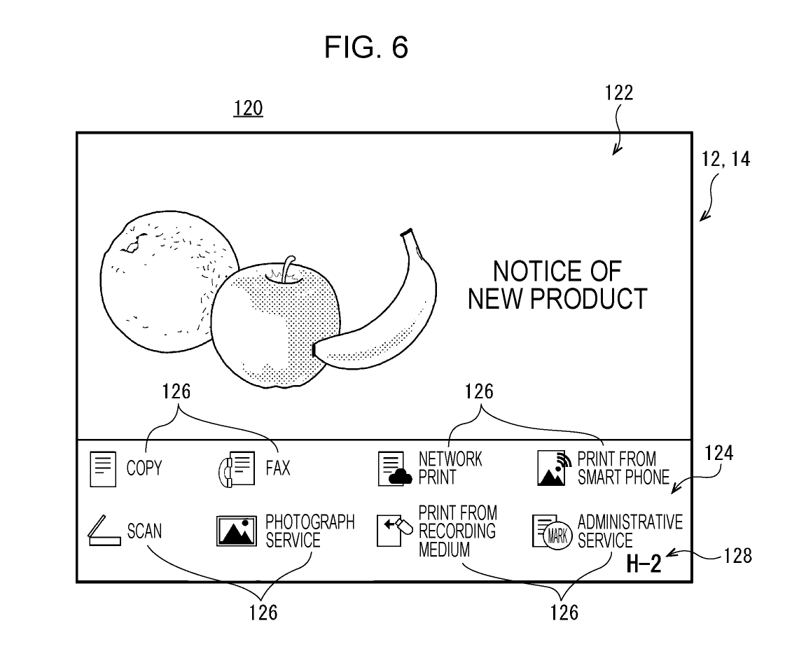

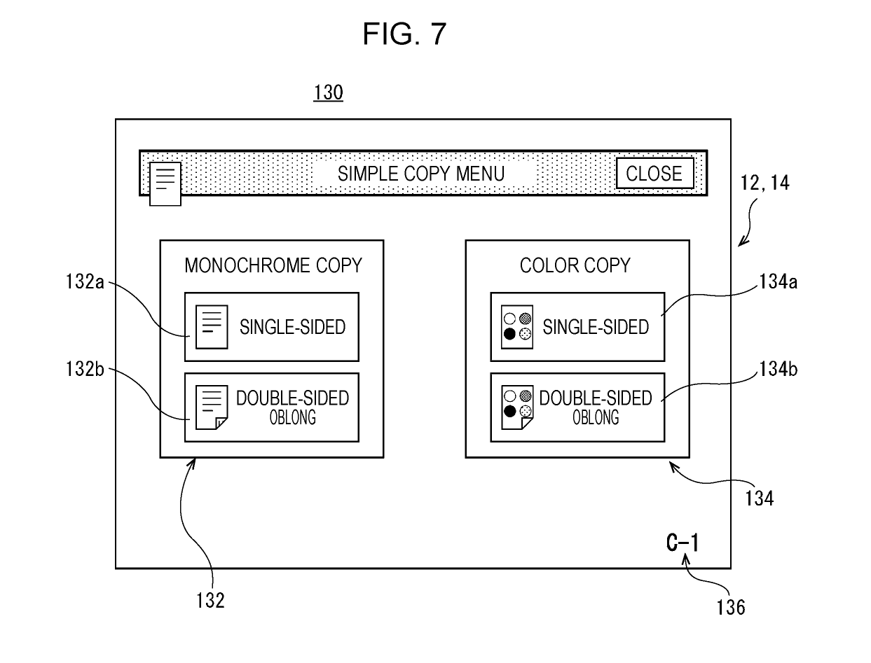

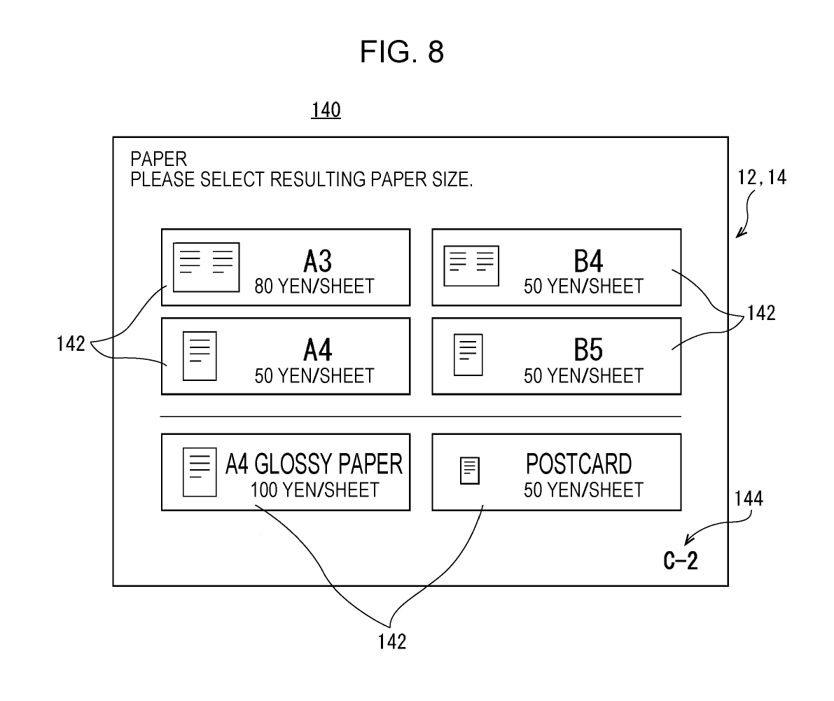

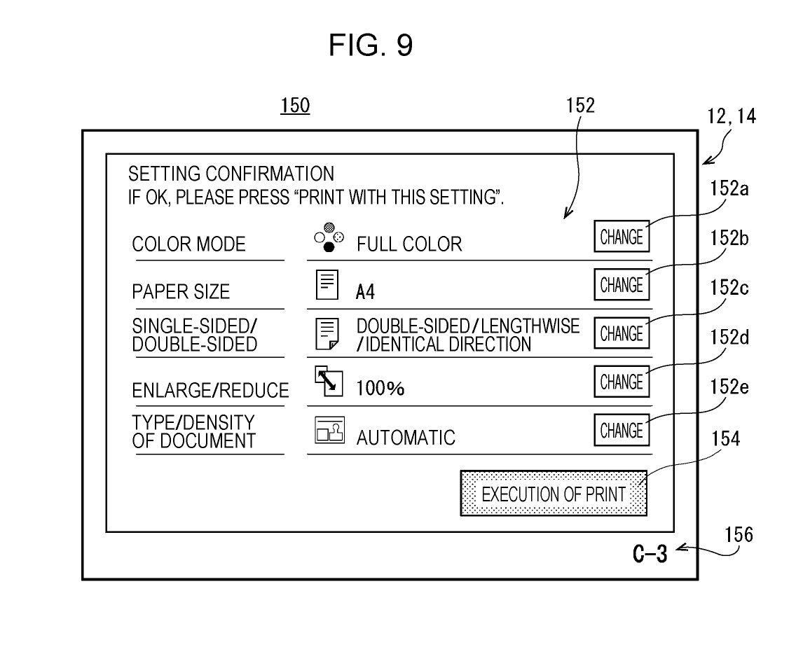

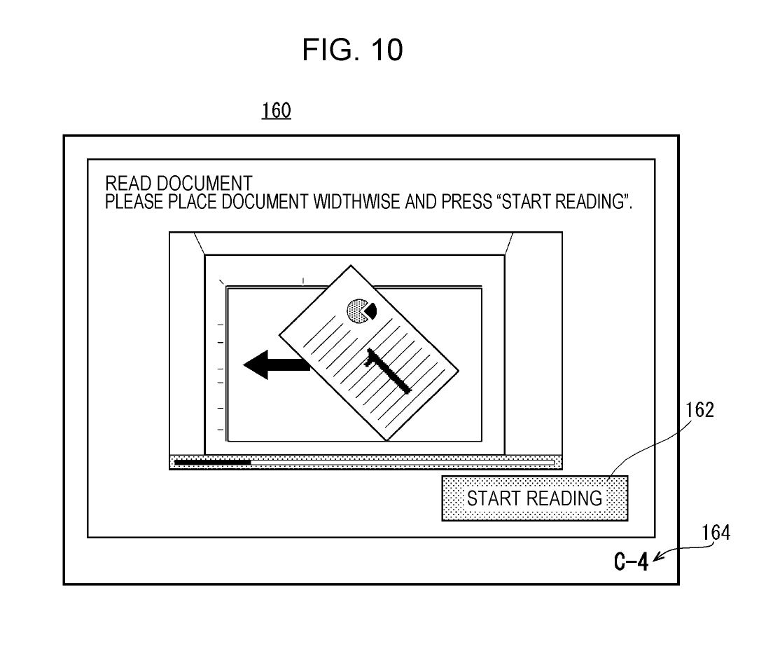

Hereinafter, an example of an operation of the information processing system 100 will be described with reference to FIGS. 5 to 10. FIG. 5 is a diagram illustrating an example of a first home screen 110. FIG. 6 is a diagram illustrating an example of a second home screen 120. FIG. 7 is a diagram illustrating an example of a first copy setting screen 130. FIG. 8 is a diagram illustrating an example of a second copy setting screen 140. FIG. 9 is a diagram illustrating an example of a third copy setting screen 150. FIG. 10 is a diagram illustrating an example of a fourth copy setting screen 160.

In a case where a main power supply for each of the information processing device 10 and the image forming device 70 is turned on and the information processing device 10 and the image forming device 70 are in a waiting state capable of performing respective functions, the first home screen 110 as illustrated in FIG. 5 is displayed on the display 14 of the information processing device 10. The first home screen 110 is one of home screens (operation screens) to select the various jobs. Here, in the first embodiment, the job indicates copy, scan, print, transmission of the facsimile, or the like. In the first home screen 110, a plurality of icons 112 to select corresponding jobs and identification information 114 are displayed.

Each of the plurality of icons 112 is an image surrounded by an approximately rectangular frame, and functions as a software key. A Job, such as “copy”, “scan, “facsimile”, “print from the recording medium”, “network print”, “photograph service”, “administrative service” or “print from a smart phone” is assigned to each of the plurality of icons 112.

The identification information 114 is information to specify the first home screen 110, and is displayed at a lower right of the first home screen 110. The identification information 114 is, for example, a string acquired by combining an alphabet and a number. In the first embodiment, the identification information 114 which indicates the first home screen 110 is “H-1”. Meanwhile, the text “H” of a first code (the leftmost side code) of the identification information 114 indicates the home screen, and the number “1” of a second code (a second text from the left) of the identification information 114 indicates a first type screen of the home screens. Meanwhile, a hyphen “-” between the first code and the second code of the identification information 114 is provided to easily distinguish between the first code and the second code.

In addition, if a state in which the information processing system 100 is not used by the user is continued, the second home screen 120 is displayed on the display 14 of the information processing device 10, as illustrated in FIG. 6. The second home screen 120 is one of the home screens to select various jobs. In addition, the second home screen 120 is divided into higher and lower parts, and includes two areas (a first area 122 and a second area 124).

The first area 122 is a higher-side area of the second home screen 120, and is an area to display an advertisement image or the like. In the first area 122, various pieces of information or pieces of information relevant to services are displayed, which the information processing system 100 is capable of providing. Specifically, in the first area 122, moving images, strings, or the like relevant to the various pieces of information or the services are displayed.

The second area 124 is a lower-side area of the second home screen 120, and is an area to select the various jobs. In the second area 124, a plurality of icons 126 to select the respective jobs, and identification information 128 are displayed.

Each of the plurality of icons 126 functions as the software key, similar to the icon 112. In addition, the job is assigned to each of the plurality of icons 126. Meanwhile, the type and number of the icon 126 are similar to those of the icon 112, and each of the plurality of icons 126 corresponds to any of the plurality of icons 112.

The identification information 128 is information to specify the second home screen 120, and is displayed at a lower right of the second area 124 (second home screen 120). For example, the identification information 128, which indicates the second home screen 120, is “H-2”. Meanwhile, the number “2” of a second code of the identification information 128 indicates a second type screen of the home screens.

Meanwhile, the first area 122 and the second area 124 may be turned upside down. That is, the second area 124 may be a higher-side area of the second home screen 120, and the first area 122 may be a lower-side area of the second home screen 120.

In addition, in a case where an area in the first area 122 is touched, an operation image relevant to an advertisement image, which is displayed when the area of the first area 122 is touched, may be displayed on the display 14, or the above-described first home screen 110 may be displayed on the display 14.

In a case where the icon 112 is touched (selected) in the first home screen 110 or in a case where the icon 126 is touched in the second home screen 120, the plurality of setting screens to set the jobs assigned to the icons 112 or icons 126 are sequentially displayed on the display 14.

For example, in a case where the icon 112 to which a copy job is assigned is touched (the copy job is selected) in the first home screen 110, a first copy setting screen 130 is displayed on the display 14, as illustrated in FIG. 7. The first copy setting screen 130 is a screen, which is initially displayed, in the plurality of setting screens (the plurality of operation screens relevant to the copy job) to perform a setting of the copy job. That is, the first copy setting screen 130 may be a first class screen in the plurality of operation screens relevant to the copy job.

The first copy setting screen 130 includes a first setting area 132, a second setting area 134, and identification information 136.

The first setting area 132 and the second setting area 134 are areas to perform a basic setting of the copy job. The basic setting of the copy job refers to a setting of monochrome copy/color copy and a setting of single-sided copy/double-sided copy.

The first setting area 132 is an area which includes an icon 132a and an icon 132b and which is used to perform the setting of single-sided copy/double-sided copy in monochrome copy. A setting of monochrome single-sided copy is assigned to the icon 132a. A setting of monochrome double-sided copy is assigned to the icon 132b.

The second setting area 134 is an area which includes an icon 134a and an icon 134b and which is used to perform the setting of the single-sided copy/double-sided copy in the color copy. A setting of color single-sided copy is assigned to the icon 134a. A setting of color double-sided copy is assigned to the icon 134b.

When any of the icon 132a and the icon 132b or any of the icon 134a and the icon 134b is touched, the basic setting of the copy job is determined.

The identification information 136 is information to specify the first copy setting screen 130. The identification information 136 is displayed at lower right of the first copy setting screen 130. The display of the identification information 136 is the same as in pieces of identification information 144, 156, 164, and the like, which will be described later. For example, the identification information 136 which indicates the first copy setting screen 130 is “C-1”. Meanwhile, the text “C” of a first code of the identification information 136 indicates an operation screen relevant to the copy job, and the number “1” of a second code of the identification information 136 indicates a first class screen of the copy setting screens.

In addition, a close icon is provided in the first copy setting screen 130. When the close icon is touched, content which is set until that time is reset, and the first home screen 110 is displayed on the display 14. The close icon is the same as in the second copy setting screen 140, the third copy setting screen 150, the fourth copy setting screen 160, and the like, which will be described later.

When the basic setting of the copy job is determined in the first copy setting screen 130, the second copy setting screen 140 is displayed on the display 14, as illustrated in FIG. 8. The second copy setting screen 140 is, for example, a screen to perform a setting of copy paper, and is a second class screen (screen which is secondly displayed) in the plurality of operation screens relevant to the copy job.

The second copy setting screen 140 includes a plurality of icons 142 and identification information 144.

The setting of the copy paper having different sizes is assigned to each of the plurality of icons 142. When any of the plurality of icons is touched, the setting of the copy paper is determined.

The identification information 144 is information to specify the second copy setting screen 140. For example, the identification information 144, which indicates the second copy setting screen 140, is “C-2”. Meanwhile, the number “2” of a second code of the identification information 144 indicates the second class screen in the plurality of operation screens relevant to the copy job.

When the setting of the copy paper is determined in the second copy setting screen 140, the third copy setting screen 150 is displayed on the display 14, as illustrated in FIG. 9. The third copy setting screen 150 is a screen to confirm the settings relevant to the copy job, which are set in the first copy setting screen 130, the second copy setting screen 140, and the like, and to change the settings for respective setting items, and is a third class screen (screen which is thirdly displayed) in the plurality of operation screens relevant to the copy job.

The third copy setting screen 150 includes a confirmation area 152, a print execution icon 154, and the identification information 156.

The confirmation area 152 is an area to confirm and change the settings relevant to the copy job for the respective setting items. The settings for the respective setting items are displayed in the confirmation area 152. In addition, the confirmation area 152 includes change icons 152a to 152e. The respective change icons 152a to 152e are provided for the respective setting items which are displayed in the confirmation area 152. When any of the change icons 152a to 152e is touched, a window to change the setting of the relevant setting item (the color mode, the paper size, or the like) is displayed, or the screen switches to the screen (for example, the first copy setting screen 130, or the like) to change the setting.

A function of instructing the copy job to be executed is assigned to the print execution icon 154. When the print execution icon 154 is touched, the copy job is executed according to the setting of the copy job.

The identification information 156 is information to specify the third copy setting screen 150. For example, the identification information 156, which indicates the third copy setting screen 150, is “C-3”. Meanwhile, the number “3” of a second code of the identification information 156 indicates the third class screen in the plurality of operation screens relevant to the copy job.

When the setting of the copy paper is determined in the third copy setting screen 150, the fourth copy setting screen 160 is displayed on the display 14, as illustrated in FIG. 10. The fourth copy setting screen 160 is a screen to read a document and is a fourth class screen (screen which is fourthly displayed) in the plurality of operation screens relevant to the copy job.

The fourth copy setting screen 160 includes a reading start icon 162 and the identification information 164. In addition, an image or the like, which explains a document placement method, is displayed on the fourth copy setting screen 160, as illustrated in FIG. 10.

A function of instructing the document to be read is assigned to the reading start icon 162. When the reading start icon 162 is touched, reading of the document is performed.

The identification information 164 is information to specify the fourth copy setting screen 160. For example, the identification information 164, which indicates the fourth copy setting screen 160, is “C-4”. Meanwhile, the number “4” of a second code of the identification information 164 indicates a fourth class screen in the plurality of operation screens relevant to the copy job.

As described above, the plurality of operation screens relevant to the copy job are sequentially displayed. The copy job is executed according to the settings of the copy job determined (selected) in the respective operation screens.

In the first embodiment, the identification information to specify the screen is embedded in each screen which is displayed on the display 14 of the information processing device 10. Therefore, the user of the information processing system 100 may transmit the identification information to the operator, and thus information is properly transmitted to the operator even in a case where content of the operation screen is not known. In addition, it is possible for the operator to specify the screen, which is currently displayed in the information processing device 10, according to the identification information transmitted from the user. Furthermore, it is possible for the operator to provide proper guide for the user according to the screen which is currently displayed in the information processing device 10.

### Second Embodiment

An information processing device 10 according to a second embodiment is the same as that in the first embodiment other than a fact that a plurality of operation screens corresponding to a certain class exist. Therefore, content which is different from the first embodiment will be described and overlapping description will not be repeated.

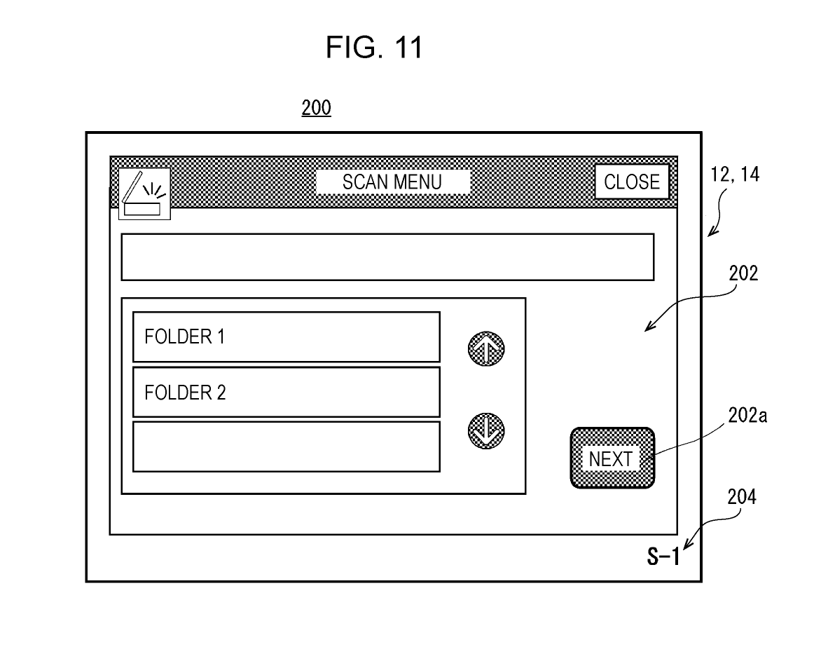

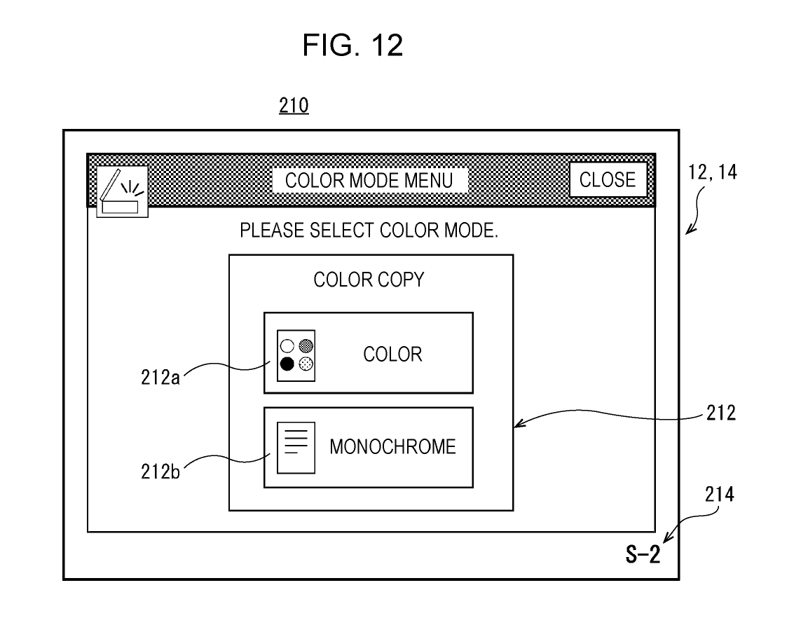

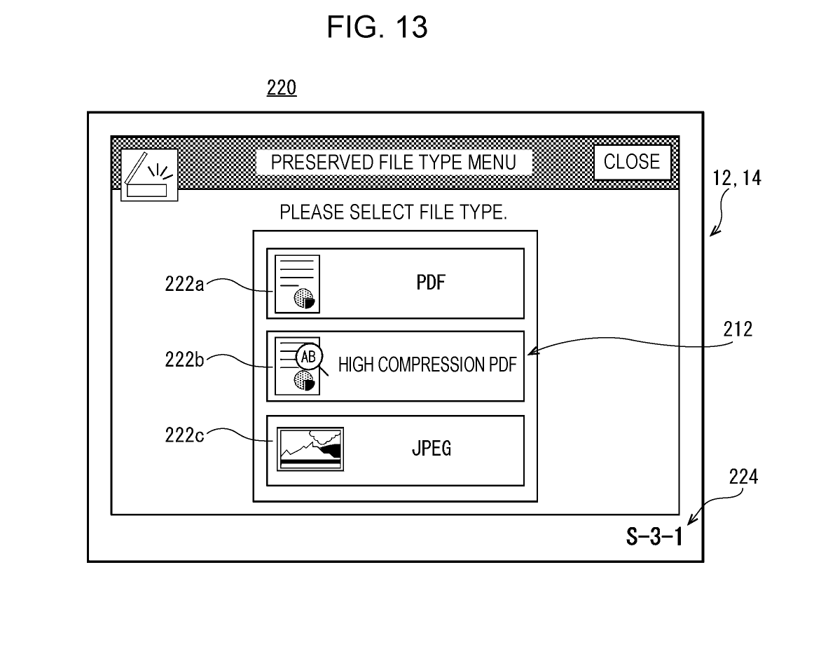

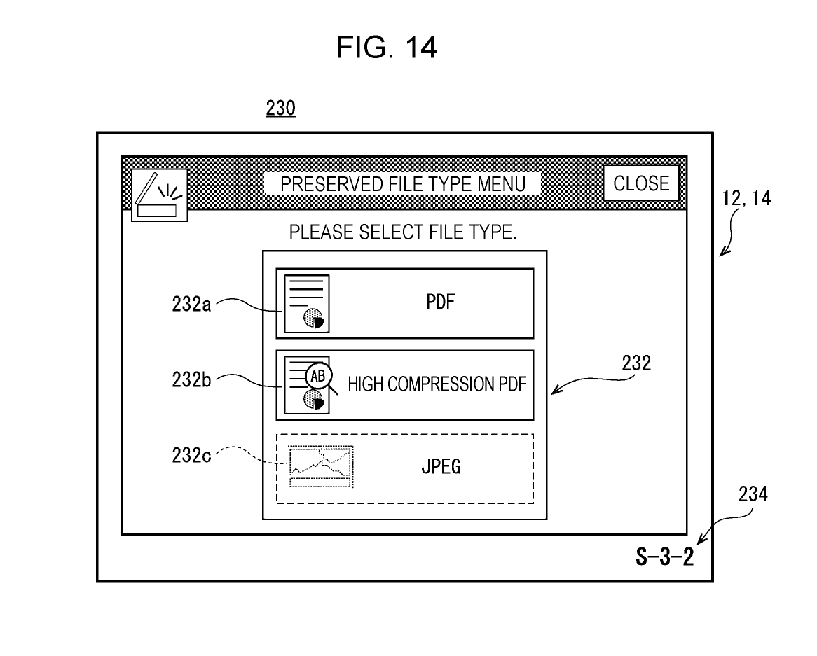

An example of an operation of the information processing system 100 according to the second embodiment will be described with reference to FIGS. 11 to 14. FIG. 11 is a diagram illustrating an example of a first scan setting screen 200 according to the second embodiment. FIG. 12 is a diagram illustrating an example of a second scan setting screen 210 according to the second embodiment. FIG. 13 is a diagram illustrating an example of a color setting screen 220 according to the second embodiment. FIG. 14 is a diagram illustrating an example of a monochrome setting screen 230 according to the second embodiment.

For example, when an icon 112, to which a scan job is assigned, is touched (the scan job is selected) in the first home screen 110 illustrated in FIG. 5, the first scan setting screen 200 is displayed on the display 14, as illustrated in FIG. 11. The first scan setting screen 200 is a screen, which is initially displayed, of a plurality of setting screens (a plurality of operation screens relevant to the scan job) to perform a setting of the scan job. That is, the first scan setting screen 200 may be a first class screen in the plurality of operation screens relevant to the scan job.

The first scan setting screen 200 includes a setting area 202 and identification information 204.

The setting area 202 is an area to perform a setting of a storage destination of read image data which is scanned. An icon 202a to proceed to a subsequent setting screen is displayed in the setting area 202. When the storage destination of the read image data is determined and the icon 202a is touched, the display of the display 14 switches to a subsequent setting screen.

The identification information 204 is information to specify the first scan setting screen 200. For example, the identification information 204, which indicates the first scan setting screen 200, is “S-1”. Meanwhile, the text “S” of a first code of the identification information 204 indicates a plurality of operation screens relevant to the scan job, and the number “1” of a second code of the identification information 204 indicates a first class screen in the plurality of operation screens relevant to the scan job.

When the icon 202a is touched in the first scan setting screen 200, the second scan setting screen 210 is displayed on the display 14, as illustrated in FIG. 12. The second scan setting screen 210 is a second class screen in the plurality of operation screens relevant to the scan job.

The second scan setting screen 210 is, for example, a screen to perform a setting of a scan color mode, and includes a setting area 212 and identification information 214.

The setting area 212 is an area to perform a setting of the color mode. Specifically, a setting is performed in the setting area 212 as to in which type of color or monochrome the document is read. The setting area 212 includes a color icon 212a and a monochrome icon 212b. A setting, in which the document is read in color, is assigned to the color icon 212a. A setting, in which the document is read in two monochrome colors, is assigned to the monochrome icon 212b.

The identification information 214 is information to specify the second scan setting screen 210. For example, the identification information 214, which indicates the second scan setting screen 210, is “S-2”. Meanwhile, the number “2” of a second code of the identification information 214 indicates the second class screen in the plurality of operation screens relevant to the scan job.

When any of the color icon 212a and the monochrome icon 212b is touched in the second scan setting screen 210, the setting of the color mode is determined, and a subsequent setting screen is displayed. However, in a case where the color icon 212a is touched, the color setting screen 220 is displayed on the display 14, as illustrated in FIG. 13. In contrast, in a case where the monochrome icon 212b is touched, the monochrome setting screen 230 is displayed on the display 14, as illustrated in FIG. 14. As described above, a plurality of third class screens exist in the plurality of operation screens relevant to the scan job. That is, a third class operation screen to be displayed on the display 14 is determined according to an operation performed by the user in the second scan setting screen 210. It may be said that an operation screen of a subsequent class branches (branch screen exists) according to the user operation performed in the operation screen of the certain class.

As illustrated in FIG. 13, the color setting screen 220 is a screen to perform a setting of a file format of the read image data which is scanned in color, and includes a setting area 222 and identification information 224.

The setting area 222 includes a Portable Document Format (PDF) icon 222a, a high compression PDF icon 222b, and a Joint Photographic Experts Group (JPEG) icon 222c. A setting, in which the scanned read image data is generated as PDF data, is assigned to the PDF icon 222a. A setting, in which the scanned read image data is generated as high compression PDF data, is assigned to the high compression PDF icon 222b. Meanwhile, the high compression PDF data is PDF data which is acquired by dividing the image data into a background part and a text part and performing compression processes which are optimal for the respective parts. A setting, in which the scanned read image data is generated as JPEG format data, is assigned to the JPEG icon 222c.

The identification information 224 is information to specify the color setting screen 220. For example, the identification information 224, which indicates the color setting screen 220, is “S-3-1”. Meanwhile, the number “3” of a second code (second text from the left) of the identification information 224 indicates the third class screen in the plurality of operation screens relevant to the scan job. In addition, the number “1” of a third code (third text from the left) of the identification information 224 indicates a first type screen in the third class operation screens relevant to the scan job.

When any of the PDF icon 222a, the high compression PDF icon 222b, and the JPEG icon 222c is touched in the color setting screen 220, the setting of the file format of the read image data is determined and a subsequent setting screen is displayed.

As illustrated in FIG. 14, the monochrome setting screen 230 is a screen to perform the setting of the file format of the read image data which is scanned in monochrome, and includes a setting area 232 and identification information 234.

The setting area 232 has the same configuration as the above-described setting area 222 of the color setting screen 220, and includes a PDF icon 232a, a high compression PDF icon 232b, and a JPEG icon 232c. However, in the monochrome setting screen 230, the JPEG icon 232c is invalid and is not selected even in when the JPEG icon 232c is touched.

The identification information 234 is information to specify the monochrome setting screen 230. For example, the identification information 234, which indicates the monochrome setting screen 230, is “S-3-2”. Meanwhile, the number “2” of a third code of the identification information 234 indicates the second type screen in the third class operation screens relevant to the scan job.

When any of the PDF icon 232a and the high compression PDF icon 232b is touched in the monochrome setting screen 230, the setting of the file format of the read image data is determined and a subsequent setting screen is displayed.

Furthermore, the setting screens for the scan job are sequentially displayed on the display 14 until the setting of the scan job is completed, and the setting of the scan job is determined according to the user operation. When the setting of the scan job is determined, the document is read by the image reading unit 72, and the read image data is generated. Here, the generated read image data is stored in the recording medium possessed by the user or is transmitted to the server, which is not illustrated in the drawing, and is stored in the storage unit of the server.

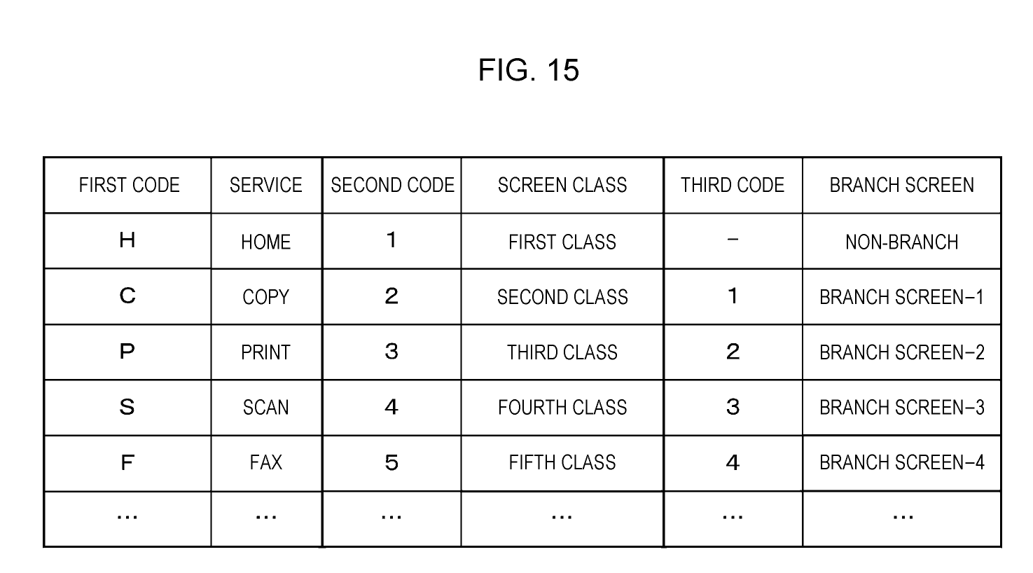

FIG. 15 is a diagram illustrating a code table according to the second embodiment. The identification information, which is embedded in each operation screen, is determined according to the code table illustrated in FIG. 15. The first code, the second code, the third code, and the like are written in the code table. Data of the code table is stored in, for example, the RAM 34 (refer to FIG. 2).

In an example of the code table illustrated in FIG. 15, in a field of the first code, an alphabet is written according to the service (function) which is allowed to be provided in the information processing device 10 or the image forming device 70. In addition, in a field of the second code, a number is written according to the class of the screen. Furthermore, in a field of the third code, a number is written according to a type of the branch screen.

According to the second embodiment, even in a case where a plurality of certain class operation screens exist, it is possible to specify the screen which is currently displayed in the information processing device 10.

### Third Embodiment

An information processing device 10 according to a third embodiment is the same as that in the first embodiment other than a fact that log information which indicates a record of the operation screen is generated. Therefore, content which is different from the first embodiment will be described and overlapping description will not be repeated.

In the information processing device 10 according to the third embodiment, display history information (log information), which indicates the kind of screen displayed at a certain timing, is generated when the information processing system 100 is used by the user. However, the log information is the identification information corresponding to the operation screen. Accordingly, log information data, which indicates the log information, is text data which indicates the identification information.

In the information processing device 10 according to the third embodiment, the log information is generated every predetermined time (30 seconds to 60 seconds) while the information processing device 10 is operated. Here, at least the log information, which is generated when an operation of the information processing device 10 starts, is automatically generated. For example, in a case where the log information is generated every 60 seconds, the log information is generated three times, that is, at a start of the operation, after 60 seconds elapse, and after 120 seconds elapse (at completion) if it is assumed that the information processing device 10 is operated for 2 minutes. That is, the log information data, which indicates the identification information corresponding to each of the operation screens displayed on the display 14, is generated in the time series at respective points of time, that is, at the start of the operation, after 60 seconds elapse, and after 120 seconds elapse.

Meanwhile, although an example in which the log information is generated every predetermined time is described, it is not desired to be limited thereto. For example, a predetermined number of (for example, 3 to 10) pieces of log information may be generated while the information processing device 10 is operated. Here, when the operation of the information processing device 10 ends, timing (time based on the start of the operation), at which the log information is generated, is set by equally dividing a period, during which the information processing device 10 is operated, by a predetermined number. Furthermore, at a point of time in which the log information is generated, the log information data, which indicates the identification information corresponding to the operation screen displayed on the display 14, is generated in the time series.

In addition, the number of pieces of log information to be generated may be automatically set according to a length of the period during which the information processing device 10 is operated. For example, in a case where the period during which the information processing device 10 is operated is short (for example, 20 seconds), the log information may be generated only two times, that is, at the start of the operation and at the completion.

The log information data, which is generated as described above, is stored in the storage unit of the information processing device 10 or is transmitted to the external computer, such as the server, through the communication circuit 44. Furthermore, when the log information data is analyzed, it is possible to evaluate the GUI or to extract an improvement point.

Although not illustrated in the drawings, the operation of the information processing device 10 is realized by executing a log information generation program stored in the RAM 34 by the CPU 32.

The log information generation program is a program to generate the log information, which indicates the screen displayed on the display 14 while the information processing device 10 is operated, in the time series.

According to the third embodiment, the log information data is text data, and thus it is possible to reduce the amount of data of the log information data. Therefore, in a case where the log information data is stored in the storage unit of the information processing device 10, it is possible to availably utilize a capacity of the storage unit of the information processing device 10. In addition, in a case where the log information data is transmitted to the external computer, it is possible to reduce communication costs and improve the communication efficiency.

Meanwhile, the detailed configurations or the like provided in the above-described embodiments are only examples, and appropriate changes according to actual products are possible.

In addition, in the above-described embodiments, the identification information, which is configured by combining the alphabet and the number, is used. However, it is not desired to be limited thereto. The identification information may be configured using another text, image, or the like which is allowed to be identified by humans. For example, the text includes an emoticon, a symbol, and a sign in addition to hiragana, katakana, Chinese character, alphabet, Korean alphabet, and a number (an arithmetic numeral, an Arabic numeral, or the like). In addition, the image includes a picture, a figure, or the like. For example, the figure includes a double circle “⊙”, a circle “◯”, a triangle “Δ”, an x mark “x”, or the like.

Furthermore, in the above-described embodiments, although the identification information is displayed at lower right of each operation screen, it is not desired to be limited thereto. The identification information may be recognizable by the user and may be displayed in the screen of each operation screen.

In addition, in the above-described embodiments, the information processing device 10 includes the display 14 equipped with the touch panel 12 and the operation screen is displayed on the display 14. However, it is not desired to be limited thereto. For example, the image forming device 70 may include the display (corresponding to the first display) equipped with the touch panel. In this case, the display 14 equipped with the touch panel 12 of the information processing device 10 may be omitted, and the information processing device 10 may include the display 14 equipped with the touch panel 12 (a configuration in which both of the information processing device 10 and the image forming device 70 include the display equipped with the touch panel). However, in a case where the display 14 equipped with the touch panel 12 of the information processing device 10 is omitted, the operation screen is displayed on the display of the image forming device 70. In addition, in a case where both of the information processing device 10 and the image forming device 70 include the display equipped with the touch panel, the operation screen may be displayed on each of the displays or the operation screen may be displayed on any of the displays. In a case where the operation screen is displayed on the display of the image forming device 70, it is possible for the user to perform the job setting or the like in the operation screen through the touch input to the touch panel of the image forming device 70.

The present disclosure contains subject matter related to that disclosed in Japanese Priority Patent Application JP 2017-212189 filed in the Japan Patent Office on Nov. 1, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device including a first display and capable of performing a predetermined function, the information processing device comprising
a first display control section that causes a plurality of operation screens for performing the predetermined function to be switched, and causes the first display to display an operation screen, wherein
in each of the plurality of operation screens, identification information corresponding to the operation screen is displayed.

2. The information processing device according to claim 1, further comprising
a generation section that generates log information, which indicates a record of the operation screen displayed on the first display, in time series, wherein
the log information is the identification information corresponding to the operation screen.

3. The information processing device according to claim 2, wherein
the generation section generates the log information every predetermined time while the information processing device is operated.

4. The information processing device according to claim 2, wherein
the generation section generates the log information corresponding to a predetermined number while the information processing device is operated.

5. The information processing device according to claim 2, wherein
the generation section automatically sets a number, in which pieces of log information are generated, according to a length of a period during which the information processing device is operated.

6. The information processing system comprising:
an information processing device according to claim 1; and
an image forming device capable of performing communication with the information processing device, wherein
the predetermined function is performed in cooperation with the information processing device and the image forming device.

7. The information processing system comprising:
an information processing device according to claim 1; and
an operator information processing device operated by an operator in a call center, wherein
the information processing device further includes a call device to make a call with the operator in the call center,
the operator information processing device includes a second display, an acquisition section, and a second display control section,
the acquisition section acquires the identification information according to an operation of the operator, and
the second display control section causes the second display to display the operation screen corresponding to the identification information acquired by the acquisition section.

8. The information processing system according to claim 7, further comprising
an image forming device capable of performing communication with the information processing device, wherein
the predetermined function is performed in cooperation with the information processing device and the image forming device.
